(19) United States
(12) Patent Application Publication
(10) Pub. No.: US 2007/0055002 A1
(43) Pub. Date: Mar. 8, 2007

(54) Paint compositions containing an additive to reduce the effect of viscosity loss caused by the addition of colorants

(75) Inventors: Barbara A. Campbell, Bristol, PA (US); Mark A. Paczkowski, Andover, NJ (US); Richard Geurtsen, Robbinsville, NJ (US)

Correspondence Address: MORGAN, LEWIS & BOCKIUS LLP, 1701 MARKET STREET, PHILADELPHIA, PA, 19103-2921, US

(73) Assignee: Elementis Specialties, Inc.

(21) Appl. No.: 11/517,692

(22) Filed: Sep. 7, 2006

Related U.S. Application Data
(60) Provisional application No. 60/714,946, filed on Sep. 7, 2005.

(51) Int. Cl. C08G 18/42

(52) U.S. Cl. 524/500

(57) ABSTRACT

A water-borne latex paint system, comprising a base paint, an associative thickener, a colorant compound, and at least 0.1% dry weight of a block copolymer ABCBA composition. For the ABCBA polymer wherein the A component is a hydrophobic group A, the B component is a hydrophilic polymer B and the C component is a low molecular weight hydrophobic group C. The ABCBA-type polymer includes an A component which is a monomer unit containing a moiety selected from the group consisting of an alkyl group, an aryl group or an alkyl aryl group, the B component includes poly(ethylene glycol), and the C component is selected from the group of diols consisting of poly(tetrahydrofuran), poly(caprolactone) poly(carbonate), ethylene glycol, propylene glycol, and 1,2-dodecanediol. The block copolymer acts as a viscosity stabilizer in the presence of associative thickeners.

### RELATED APPLICATIONS

This application claims the benefit of U.S. Provisional Application No. 60/714,946, filed Sep. 7, 2005, entitled Improved Paint Compositions Containing an Additive to Reduce the Effect of Viscosity Loss caused by the Addition of Colorants, which is incorporated herein by reference in its entirety.

### FIELD OF THE INVENTION

The present invention relates to an improved paint compositions and, more particularly, to an additive composition to be used in water-borne latex paints to reduce the disruption of an associative thickener network upon the addition of colorants, as well as a novel process for producing the improved paint compositions.

### SUMMARY OF THE INVENTION

In one embodiment, this invention relates to improved paint compositions containing an additive to reduce the effect of viscosity loss caused by the addition of colorants.

One aspect of the invention relates to a water-borne latex paint system, comprising a base paint, an associative thickener, a colorant compound, and at least 0.1% dry weight of a block copolymer ABCBA composition. The block copolymer acts as a viscosity stabilizer in the presence of associative thickeners.

Another aspect of the invention relates to a method of formulating a water-borne latex paint system, comprising adding to a base paint, an associative thickener and a colorant compound and further adding at least 0.1% dry weight of a block copolymer ABCBA composition. In one embodiment, the ABCBA copolymer contains an A component including a monomer unit containing a moiety selected from the group consisting of an alkyl group, an aryl group or an alkyl aryl group, the B component includes poly(ethylene glycol), and the C component is selected from the group of diols consisting of poly(tetrahydrofuran), poly(caprolactone) poly(carbonate), ethylene glycol, propylene glycol, and 1,2-dodecanediol.

Yet another aspect of the invention relates to a polymer chemical which is made by reacting a poly(ethylene) glycol, and a diol comprising one or more of the following diols: poly(tetrahydrofuranol), poly(caprolactone), poly(carbonate), ethylene glycol, propylene glycol, and 1,2-dodecanediol and a monomer unit containing a moiety selected from the group consisting of an alkyl group, an aryl group or an alkyl aryl group.

### BRIEF DESCRIPTION OF THE DRAWINGS

The accompanying drawing, which is included to provide further understanding of the invention and is incorporated in and constitute a part of this specification, illustrate embodiments of the disclosure and, together with the description, serve to explain the principles of the disclosure.

In the drawings:

FIG. 1. illustrates a plot of Stormer viscosity of a model deep tint base formulation using a commercial associative thickener Rheolate® 255 (10.75 weight percent dry loading) as a function of Colortrend 888 Lampblack (9907) colorant concentration;

FIG. 2. illustrates a plot of Stormer viscosity of a model deep tint base formulation using a commercial associative thickener Rheolate® 255 (@ 0.75 weight percent dry loading) and the inventive color viscosity stabilizer (@ 0.75 weight percent dry loading) as a function of Colortrend 888 Lampblack (9907) colorant concentration; and

FIG. 3. illustrates a plot of the Stormer viscosity drop of a model deep tint base formulation using a commercial associative thickener Rheolate® 255 (@ 0.75 weight percent dry loading) and with 10 weight % Colortrend 888 Lamblack (9907) as a function of the concentration of the inventive viscosity stabilizer.

### DESCRIPTION OF THE EMBODIMENTS

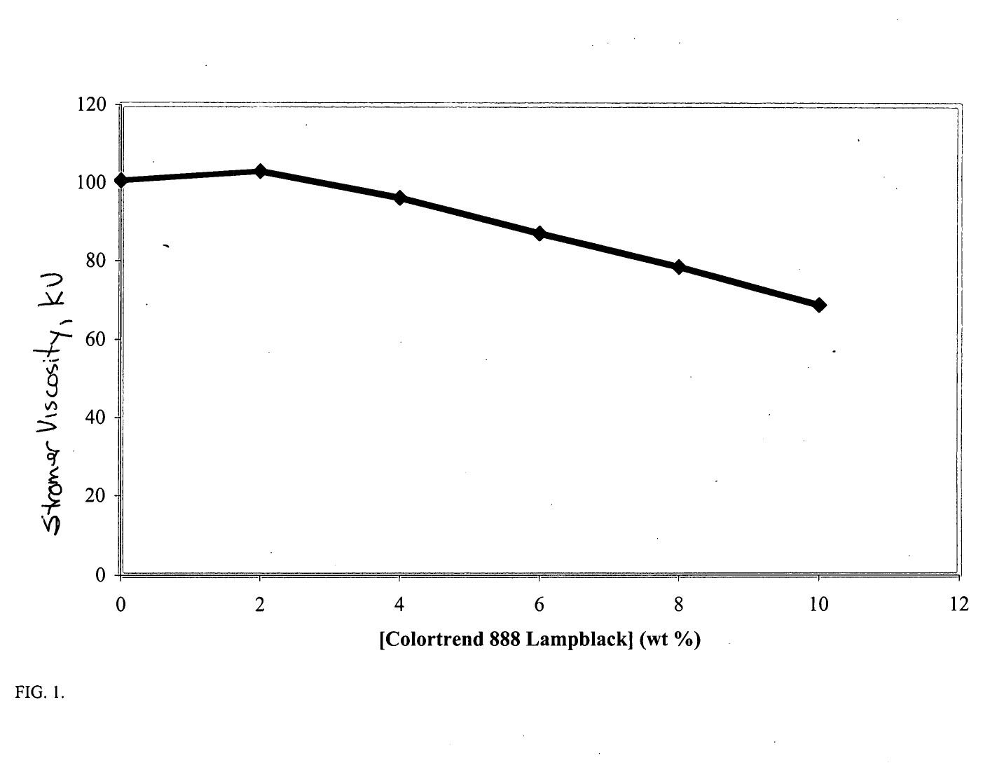

In certain water based paint system, it is desirable to maintain the paint's mid-shear (or Stormer) viscosity by ±10% of its base value. For pastel bases, in certain embodiments, this would include up to 2 fluid ounces of colorant; for mid-tone bases, this would include up to 4 fluid ounces; and for deep tint bases, this would include up to 12 fluid ounces of colorants. In certain embodiments, it is also desirable that the viscosity drop does not depend on the color of the tinting formulation or “colorant”—e.g. blue vs. black vs. red, etc. The extent of the viscosity drop observed with the addition of colorant depends on the efficiency of the associative thickener—i.e. the amount of thickener needed to obtain a predetermined viscosity—and usually, the more efficient the associative thickener, the larger the drop in the observed viscosity. As an example of the extent of the mid-shear viscosity decrease upon tinting, it is not unusual to observe a −30 to −40 KU (Krebs Unit—Stormer viscosity units) drop in a 90-100 KU paint. This kind of viscosity reduction results in a very fluid paint creating coating problems. FIG. 1 demonstrates the change in viscosity of a base paint upon the addition of colorant.

The viscosity drop is related to the color of the tinting formulation. This is most likely due to the quantity and type of surfactants used to stabilize the pigment in the colorant. In most cases, carbon black requires the most surfactant and therefore is the most troublesome color.

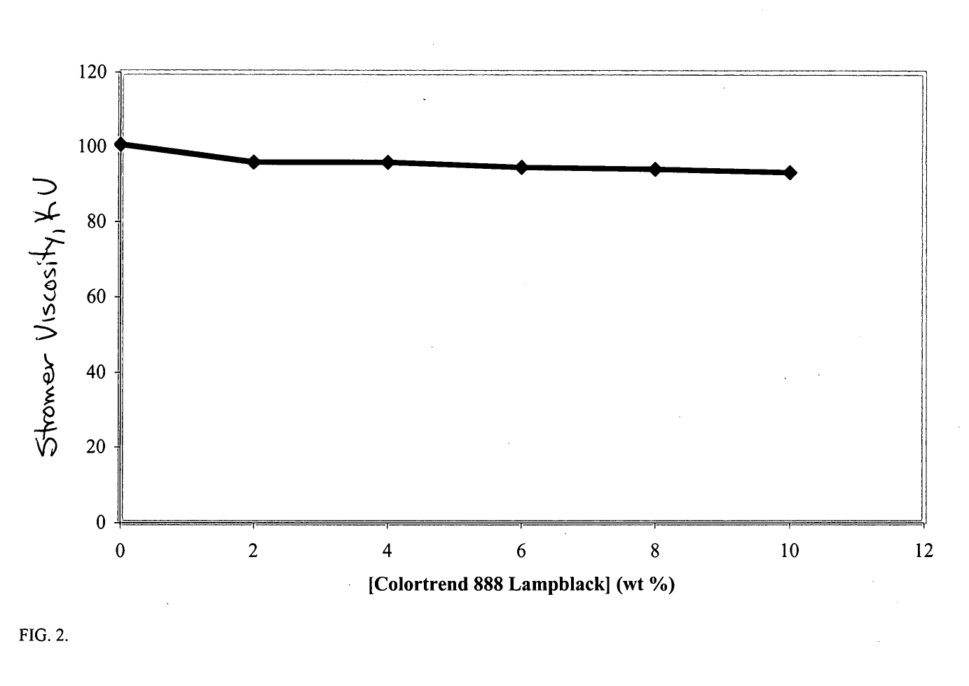

In one embodiment, an ideal stabilizing additive is added into the base paint at a level not exceeding 1 weight % of active material. With the stabilizer in the paint, the paint's viscosity remains within 10% of its base viscosity through the addition of up to 12 fluid ounces of colorant (for a deep tint base) for any color. FIG. 2 shows the change in viscosity of a 90-100 KU base paint with the addition of 0.75 wt. % of the inventive composition of the present disclosure.

In one embodiment of the invention, a polymer composition is made by reacting a monomer unit, a poly(ethylene) glycol, and linear, branched and cyclic alkyl compounds having hydroxyl or amine functionalities. In another embodiment, a polymer composition is made by reacting a monomer unit, a poly(ethylene) glycol, and a diol. In yet another embodiment, a polymer composition is made by reacting a monomer unit, a poly(ethylene) glycol, and a diamine.

In one embodiment, the polymer which is produced includes a block copolymer. The block copolymer acts as a viscosity stabilizer in the presence of associative thickeners. In another embodiment, the block copolymer is an ABCBA polymer wherein the A component is a hydrophobic group A, the B component is a hydrophilic polymer B and the C component is a low molecular weight hydrophobic C compound.

In one embodiment, the A-component, of the ABCBA copolymer, includes a monomer unit having a hydrophobic alkyl group, aryl alkyl group or an aryl group. The alkyl monomer unit may be linear, branched or cyclic and may contain heteroatoms such as O, N or S. In one embodiment, the alkyl group contains at least eight carbon atoms. In another embodiment, the A-component includes a C₁₀ to a C₂₂ alcohol. In yet another embodiment, the A-component includes a C₁₀ to a C₁₆ alcohol. In still another embodiment, the A-component may also include a C₁₀ to a C₂₂ alcohol equivalent where in equivalent means an alkyl aryl alcohol having the equivalent hydrophobicity. In another embodiment, the A-component may also include C₁₀ to a C₁₆ alcohol equivalent. In another embodiment, the number average molecular weight of the A-component ranges from about 140 to 350 g/mole. The higher the number average molecular weight of the A-component, the more efficient the additive is for maintaining viscosity of paint compositions.

In an embodiment, the A-component includes a hydrophobic alkyl aryl group or aryl group. The aryl group may contain substituents which may also contain heteroatoms such as O, N, or S. Examples of alkyl aryl groups or aryl groups include nonylphenol, dinonylphenol, and tristyryl phenol.

The viscosity stabilizer will, in part, depend upon the hydrophobicity of the A-component. The hydrophobicity of the A-component is related to its partition coefficient (log P or log W). A viscosity stabilizer having A-component with a high log P, demonstrates a greater degree of viscosity stabilization compared to viscosity stabilizer having A-component with a low log P.

In one embodiment, the B-component is a hydrophile such as poly(ethylene glycol). The B-component may have about 25 to 150 ethoxy repeat units. Preferably, the B-component has about 40 to 60 ethoxy repeat units. In one embodiment, the number average molecular weight of the hydrophilic B-component must be high enough to provide water solubility to the polymer so that the material disperses in a fully formulated paint. A high number average molecular weight decreases the effectiveness of the stabilizer and changes the shear viscosity profile. In one embodiment, the number average molecular weight of the B-component ranges from about 1000-6000.

In one embodiment, the C-component includes a hydrophobic low molecular weight linear, branched and cyclic alkyl diols which may also contain heteroatoms such as O, N, or S. In one embodiment, the C-component includes a hydrophobic low molecular weight water insoluble diol polymers such as poly(tetrahydrofuran), poly(caprolactone), poly(tetrahydrofuran carbonate), poly(carbonate), poly(ethylene-co-1,2-butylene), poly(propylene oxide) and poly(methylene). In another embodiment, diols such as ethylene glycol, propylene glycol, butanediol, 2-butyl-2-ethyl-1,3-propanediol, 1,12-dodecanediol, 1,2-dodecanediol may also be used to create the C-component as long as the A- and B-components are adjusted to produce a polymer which can self-disperse in water. The molecular weight of the C-component is also important and should be balanced against the molecular weight of the B-component so as to create a material that is too insoluble or too soluble. Generally, the higher the number average molecular weight of the C-component, the more insoluble the viscosity stabilizer additive. In one embodiment, the C-component has number average molecular weights ranging from about 28 to 1000. In a preferred embodiment, the C-component has number average molecular weights ranging from about 50 and 1000.

In another embodiment, the ABCBA block copolymer contains at least two linking units. The linking units may include urethane linking unit, an ester linking unit, an amide linking unit, and/or an urea linking unit. In one embodiment, the linking units include urethane links obtained from compounds of hexamethylene diisocyanate, trimethyl hexamethylene diisocyanate, isophorone diisocyanate, tetramethyl xylene diisocyanate, and/or 4,4-methylene bis(cyclohexylisocyanate). In a preferred embodiment, the urethane link is obtained from hexamethylene diisocyanate.

In one embodiment, the block co-polymer is synthesized using an ethoxylated alcohol for the AB-blocks, a diisocyanate for a linking unit, and a diol is the C-block. In certain embodiments, the ratio of these components (ethoxylated alcohol, diisocyanate, and diol) ranges from about 2:2:0.9 to 2:2:1.2. In a preferred embodiment, the ratio of components is about 2:2:1.

These stabilizers are most conveniently synthesized from alkyl, aryl or alkyl-aryl ethoxylates, of the form R—O—(CH₂CH₂O)ₙ—H, a diisocyanate, and a diol, where R—O—(CH₂CH₂O)ₙ—H contributes both the A component and the B component. There are many ways to produce a copolymer with the ABCBA structure. In one embodiment, the polymer is produced through the reaction of an aryl or alkyl or aryl alkyl ethoxylate with a diisocyanate in the presence of a diol as illustrated.

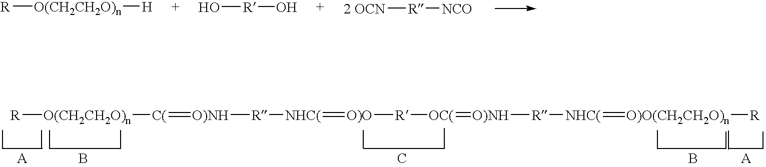

In one embodiment of this invention, the ABCBA block copolymer is used as part of a water-borne latex paint system. The water-borne latex paint system is formulated by adding to a base paint, an associative thickener and a colorant compound, and at least 0.1% dry weight of a block copolymer ABCBA composition.

In another embodiment, the water-borne latex paint system formulated by the method of the present invention contains less than 0.01 wt. % of a second polymer containing at least one hydrophilic monomer and only one hydrophobic monomer.

The stabilizer may be added to the paint as a solid or as a liquid solution with other solvents and surfactants. In certain embodiments, the co-solution of stabilizer with other surfactants may make the stabilizer less effective and therefore greater quantities of stabilizer may be required to obtain the same performance. In a solid form, in one embodiment, the material is added to the paint at the last step and then the material is dispersed with a high speed disperser or on a Red Devil shaker. In a liquid form, in certain embodiments, the material is added at any stage of the paint preparation.

The stabilizer is effective in improving the viscosity stability to colorant addition for paints containing at least one associative thickener. In certain embodiments, these include nonionic materials such as polyether and/or polyurethane associative thickeners or ionic associative thickeners such as hydrophobically modified alkali swellable (or soluble) emulsions (HASE) and hydrophobically modified hydroxyethyl cellulose.

Synthesis of Stabilizers

Generic Preparation of Stabilizer—with Solvent

To a reaction kettle equipped with a nitrogen inlet, stirrer, Dean Stark trap and a condenser, 0.03 moles of ethoxylate (e.g. lauryl ethoxylate(50)), 0.015 moles of diol (e.g. polyterahydrofuran(650) diol) and 350 ml of toluene are heated and stirred at 250 rpm until the ethoxylate is totally dissolved. Any water is azeotropically removed at ˜110° C. via the Dean Stark trap and approximately 100 ml of wet toluene is separated from the reaction. The reaction is cooled to 75° C. and 0.03 moles of diisocyanate (e.g. hexamethylene diisocyanate) is slowly added to the mixture over a period of 10 minutes. 5×10⁻⁴ mole of dibutyl tin dilaurate is then added to the mixture and the clear solution was stirred for 1 hour at 75° C. The product was isolated after the toluene was removed via vacuum distillation.

General Preparation of Stabilizer—without Solvent

To a reaction kettle equipped with a nitrogen inlet, stirrer, and a vacuum source, 0.03 moles of ethoxylate (e.g. lauryl ethoxylate(50)), 0.015 moles of diol (e.g. polyterahydrofuran(650) diol) are heated at 90° C. until the ethoxylate melts. The solution is then stirred at 250 rpm until a homogenous solution is attained. Any water is removed by vacuum distillation at 90° C. and −29″ Hg for 2 hours. The reaction is cooled to 75° C. and 5×10⁻⁴ mole of dibutyl tin dilaurate is then added to the mixture. Then, 0.03 moles of diisocyanate (e.g. hexamethylene diisocyanate) is slowly added to the mixture over a period of 30 minutes and the clear solution was stirred for an additional 15 minutes at 75° C. The product was poured off in the melt, cooled and then milled to a fine powder.

Using this method, a number of stabilizers with different A, B, and C components were synthesized as shown in Table 1.

TABLE 1

| Exam- | | | |
|---|---|---|---|
| ple | A | B | C |
| A | nonylphenol | EO(100) | poly(caprolactone) MW = 532 |
| B | nonylphenol | EO(100) | poly(tetrahydrofuran) MW = 650 |
| C | dinonylphenol | EO(150) | poly(tetrahydrofuran) MW = 650 |
| D | l-C12 | EO(50) | poly(tetrahydrofuran) MW = 650 |
| E | l-C18 | EO(23) | poly(tetrahydrofuran) MW = 650 |
| F | nonylphenol | EO(100) | poly(tetrahydrofuran carbonate) |
| | | | MW = 1000 |
| G | l-C12 | EO(100) | poly(tetrahydrofuran) MW = 650 |
| H | l-C12 | EO(150) | poly(tetrahydrofuran) MW = 650 |
| I | b-C16 | EO(50) | poly(tetrahydrofuran) MW = 650 |
| J | dinonylphenol | EO(150) | (CH₂)12 |

l = linear
EO = ethylene oxide
b = branched
(###) = number of repeat units

To test the effectiveness of these materials in model paint, we used an exterior semi-gloss deep tint base with an acrylic latex with a pigment volume concentration of 40. The formulation of this base is listed in Table 2. The rheological agent and the stabilizer were added during the viscosity adjusting step.

TABLE 2
Exterior Deep Base Eggshell Formulation

| Material | Product | Pounds | Gallons | 100% |
|---|---|---|---|---|
| Water | | 75.00 | 9.00 | 7.49 |
| Nuosept C | Biocide | 1.00 | 0.13 | 0.10 |
| Drew L464 | Defoamer | 2.00 | 0.26 | 0.20 |
| Triton N-57 | Surfactant | 1.00 | 0.12 | 0.10 |
| Tamol 731 | Dispersant | 7.00 | 0.76 | 0.70 |
| Kronos 2101 | Tio2 | 25.00 | 0.80 | 2.50 |
| Minex 7 | Nephyline Syenite | 118.00 | 5.44 | 11.79 |
| Microwhite 25 | Calcium Carbonate | 82.00 | 3.64 | 8.19 |

Mix H. S. & Add:

| | | | | |
|---|---|---|---|---|
| UCAR 625 | Acrylic Latex | 400.00 | 45.45 | 39.96 |
| Texanol | Coalescing Solvent | 16.00 | 2.02 | 1.60 |
| Ethylene Glycol | | 20.00 | 2.15 | 2.00 |
| Ammonia | Base | 3.00 | 0.36 | 0.30 |
| Drewplus L464 | Defoamer | 2.00 | 0.24 | 0.20 |

Hold For Viscosity
Adjustment

| | | | |
|---|---|---|---|
| Rheological | 20.55 | | 2.05 |
| Additive | | | |
| Water | 228.45 | 29.89 | 22.82 |
| | 1001.00 | 100.26 | 100.00 |

In all of the paints tested, we used commercial associative thickeners under the trade names of Rheolate® (Elementis Specialties) and Acrysol®(Rohm & Haas). The thickener concentration was adjusted to give paint with a Stormer viscosity between 90 and 110 KU. For single measurement comparisons, we used Degussa Colortrend 888 Lampblack (9907) colorant at a loading level of 10 weight %. For ladder studies, we used the same colorant but adjusted the concentration from 0 to 10 weight % in the tinted paint formulations. For color comparison, we used Degussa Colortrend 888 Red (1045) and Phthalo Blue (7214).

Example Paint Samples

In the model paint formulation as described above in Table 2 thickened with 0.75% by weight (based on solids) of Rheolate® 255 (Elementis Specialties, Hightstown, N.J.), 0.75% of stabilizer was added at the same time to the rheological agent and both were stirred into the paint using a Dispermat at 2000 rpm for 10 minutes. Following addition, the paint was allowed to equilibrate overnight and the Stormer viscosity was measured. Then, Degussa Colortrend Lampblack (9907) was added at a level of 10% by weight to the thickened paint and was shaken on a Red Devil paint shaker for 10 minutes. Again the colorized paint was allowed to equilibrate overnight at which the Stormer viscosity was then taken. For ladder studies in colorant concentration, the same method was used but at different concentrations of colorant.

Table 3 summarizes the results for a paint thickened with 0.75% by weight (based on solids) of Rheolate® 255 and with the various stabilizers described in Table 1. We also compare the paint response to colorant in the absence of stabilizer (CONTROL).

TABLE 3

| | | Tinted Overnight | |
|---|---|---|---|
| | Overnight Stormer | Stormer Viscosity | Viscosity |
| Example | Viscosity (KU) | (KU) | Change (KU) |
| Control | 101 | 67 | −34 |
| A | 94 | 88 | −6 |
| B | 95 | 88 | −7 |
| C | 96 | 103 | 2 |
| D | 83 | 75 | −8 |
| E | 83 | 65 | −18 |
| F | 117 | 97 | −20 |
| G | 95 | 89 | −6 |
| H | 100 | 87 | −13 |
| I | 102 | 96 | −6 |
| J | 100 | 78 | −22 |

The viscosity stabilizers of the present invention were tested to determine the effect of copolymer structure on the change in viscosity of the base paint formulation without tint. It is desirable that the viscosity stabilizers do not increase or decrease the viscosity of the base paint formulation (i.e., CONTROL). Paint formulations were prepared having loading levels of a rheological additive to obtain a base paint viscosity between 90 and 110 KU. The amount of rheological additive required for this base viscosity depends upon the formulation of the paint and the structure of the rheological additive. For example, 0.1 to 2 wt. % of Rheolate 225 is required for the base paint formulation of Table 3. The examples of Table 3 were prepared with 0.75 wt. % of viscosity stabilizer added to the base paint formulation. The viscosity stabilizer impacts the change in viscosity of the base paint formulation, without tint, to varying degrees. For example in one embodiment, the viscosity stabilizer changes the viscosity of the base paint formulation (i.e., CONTROL) by up to ±25%. In another embodiment, the viscosity stabilizer changes the viscosity of the base paint formulation (i.e., CONTROL) by up to ±20%. In yet another embodiment, the viscosity stabilizer changes the viscosity of the base paint formulation (i.e., CONTROL) by up to ±15%. In still another embodiment, the viscosity stabilizer changes the viscosity of the base paint formulation (i.e., CONTROL) by up to ±10%. As illustrated in Table 3, sample “I” increased the viscosity of the control formulation by only 1 KU (1%).

The viscosity stabilizers of the present invention were also tested to determine the effect of copolymer structure on the change in viscosity of the base paint formulation with tint. In the presence of a tint, the viscosity stabilizer diminishes the decrease in the viscosity of the paint formulation compared to the untinted stabilized formulation. For example in one embodiment, the overnight viscosity of the tinted paint formulation decreases by up to ±25% compared to the untinted stabilized formulation. In another embodiment, the overnight viscosity of the tinted paint formulation decreases by up to ±20% compared to the untinted stabilized formulation. In yet another embodiment, the overnight viscosity of the tinted paint formulation decreases by up to ±15% compared to the untinted stabilized formulation. In still another embodiment, the overnight viscosity of the tinted paint formulation decreases by up to ±10% compared to the untinted stabilized formulation. As further illustrated in Table 3 for sample “I”, the overnight viscosity of the tinted stabilized formulation was 96 KU compared to the untinted stabilized formulation having an overnight viscosity of 102 KU for a decrease of only 6 KU (6%) due to the tint. This is in contrast data for the unstabilized formulation (CONTROL). The overnight viscosity of the untinted formulation was 101 KU and the overnight viscosity of the tinted formulation was 67 KU for a decrease in viscosity of 34% due to tinting.

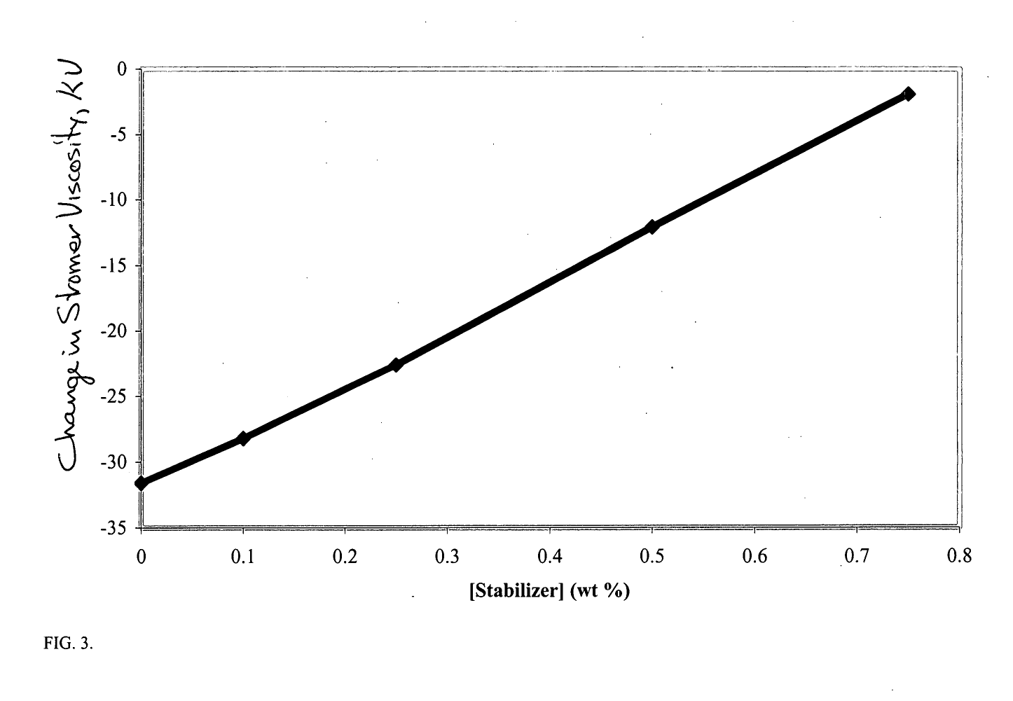

Table 4 illustrated the change in viscosity, with and without the inventive viscosity stabilizer, with various commercially available rheological additives. For example, Acrysol RM-8W thickened paint showed a decrease in viscosity of −26.4 KU in the absence of viscosity stabilizer sample I. With the addition of 0.35 wt. % of viscosity stabilizer sample I, the viscosity of the base paint formulation decreased by 12.9 KU. Additional stabilization is achieved by high levels of viscosity stabilizer as shown in FIGS. 2 and 3.

TABLE 4

| | | Stabilizer | | | | |
|---|---|---|---|---|---|---|
| | Thickener | Dry | | | | |
| | Dry | Loading | Stormer Before | | Δ Stormer After | |
| | Loading | (weight | Tinting (KU) | | Tinting (ΔKU) | |
| Thickener | (weight %) | %) | Control | w/Stabilizer | Control | w/Stabilizer |
| Acrysol RM- | 0.60% | 0.75% | 90.8 | 84.7 | −24.5 | −9.1 |
| 825 | | | | | | |
| Acrysol | 0.75% | 0.75% | 106.3 | 102.3 | −41 | −12.9 |
| SCT-275 | | | | | | |
| Acrysol RM- | 1.00% | 0.35% | 96.4 | 93 | −26.4 | −15.2 |
| 8W | | | | | | |
| Acrysol RM- | 1.28% | 0.35% | 90.9 | 92.2 | −12.3 | −5.4 |
| 870 | | | | | | |

The amount of viscosity stabilizer influences the change in viscosity of the base paint formulation with and without added tint. For sample I, the viscosity stabilization effect is linear with the concentration of the stabilizer as shown in FIG. 3 using 0.75 wt. % of the rheological agent Rheolate® 255. The concentration of the stabilizer needed to stabilize the water-borne paint system depends on the components of the paint and the efficiency of the thickener. In one embodiment, the stabilizer concentration ranges from 0.1% by weight (based on solids) to 1% by weight. In another embodiment, the stabilizer concentration ranges from 0.1% by weight (based on solids) to 5% by weight. In yet another embodiment, the stabilizer concentration ranges from 0.1% by weight (based on solids) to 1% by weight.

The effect of colorant is illustrated in Table 5. The deep tint model formulation referenced above was thickened with 0.6% by weight (based on solids) with Acrysol® RM-825 and 0.475% of Acrysol RM-2020 and then 0.75% by weight of Example “I” stabilizer was added to the paint. The paint was then tinted at 12 fluid ounces with Degussa Colortrend 888 Lampblack (9907), Red (1045), or Phthalo Blue (7214) and the before/after Stormer viscosities were compared.

TABLE 5

| | Stormer | | Stormer | | | |
|---|---|---|---|---|---|---|
| | Viscosity Before | | Viscosity After | | D Stormer | |
| | Tinting (KU) | | Tinting (KU) | | Viscosity (D KU) | |
| Color- | | w/ | | w/ | | w/ |
| ant | Control | Stabilizer | Control | Stabilizer | Control | Stabilizer |
| Red | 99 | 93 | 88 | 90 | −11 | −5 |
| Black | 99 | 93 | 77 | 88 | −22 | −3 |
| Phthalo | 99 | 93 | 82 | 90 | −17 | −3 |
| Blue | | | | | | |

In this system, the viscosity stabilizers provide viscosity stabilization for all three colors tested while only reducing the base paint viscosity by less than 7%. By comparison, the control samples showed large and variable decreases, 10% to 22%, in the Stormer viscosity upon tinting with the various colorants.

The present disclosure may be embodied in other specific forms without departing from the spirit or essential attributes of the invention. Accordingly, reference should be made to the appended claims, rather than the foregoing specification, as indicating the scope of the disclosure. Although the foregoing description is directed to the preferred embodiments of the disclosure, it is noted that other variations and modification will be apparent to those skilled in the art, and may be made without departing from the spirit or scope of the disclosure.

What is claimed:

1. A water-borne latex paint system, comprising:
(a) a base paint,
(b) an associative thickener,
(c) a colorant compound, and
(d) at least 0.1% dry weight of a block copolymer ABCBA composition.

2. The system according to claim 1, wherein the ABCBA-type polymer includes an A component comprising a hydrophobic group A, a B component comprising a hydrophilic polymer B and a C component comprising a hydrophobic low molecular weight group C.

3. The system according to claim 1, wherein the ABCBA-type polymer includes an A component comprising a monomer unit containing a moiety selected from the group consisting of an alkyl group, an aryl group or an alkyl aryl group, a B component comprising poly(ethylene glycol), and a C component selected from the group of diols consisting of poly(tetrahydrofuran), poly(caprolactone) and poly(carbonate).

4. The system according to claim 1, wherein the ABCBA-type polymer includes an A component comprising a monomer unit containing a moiety selected from the group consisting of alkyl group, aryl group or alkyl aryl group, a B component comprising poly(ethylene glycol), and a C component selected from the group of diols consisting of ethylene glycol, propylene glycol, and 1,2-dodecanediol.

5. The system according to claim 1, wherein the system contains less than 0.01 wt. % of a second polymer containing at least one hydrophilic group having a number average molecular weight of at least 1000 and only one hydrophobic group.

6. The system according to claim 1, wherein the ABCBA block copolymer contains at least two linking units.

7. The system according to claim 6, wherein said linking units comprise one or more of the following: a urethane linking unit, an ester linking unit; an amide linking unit; and an urea linking unit.

8. The system according to claim 6, wherein the linking units comprise urethane links obtained from compounds selected from the group consisting of hexamethylene diisocyanate, trimethyl hexamethylene diisocyanate, isophorone diisocyanate, tetramethyl xylene diisocyanate, and 4,4-methylene bis(cyclohexylisocyanate).

9. A method of formulating a water-borne latex paint system, comprising:
(a) adding to a base paint, an associative thickener and a colorant compound; and
(b) further adding at least 0.1% dry weight of a block copolymer ABCBA composition.

10. The method according to claim 9, wherein the ABCBA-type polymer includes an A component comprising a hydrophobic group A, a B component comprising a hydrophilic polymer B and a C component comprising a low molecular weight hydrophobic group C.

11. The method according to claim 9, wherein the ABCBA-type polymer includes an A component comprising a monomer unit containing a moiety selected from the group consisting of an alkyl group, an aryl group or alkyl aryl group, a B component selected from the group consisting of poly(ethylene glycol), and a C component selected from the group of diols consisting of poly(tetrahydrofuran), poly(caprolactone) and poly(carbonate).

12. The method according to claim 9, the ABCBA-type polymer includes an A component comprising a monomer unit containing a moiety selected from the group consisting of an alkyl group, an aryl group or alkyl aryl group, a B component comprising poly(ethylene glycol), and a C component selected from the group of diols consisting of ethylene glycol, propylene glycol, and 1,2-dodecanediol.

13. The method according to claim 9, wherein the system contains less than 0.01 wt. % of a second polymer containing at least one hydrophilic group having a number average molecular weight of at least 1000 and only one hydrophobic group.

14. The method according to claim 9, wherein the ABCBA block copolymer contains at least two linking units.

15. The method according to claim 14, wherein said linking units comprise one or more of the following: a urethane linking unit, an ester linking unit; an amide linking unit; and an urea linking unit.

16. The method according to claim 14, wherein the linking units comprise urethane links obtained from compounds selected from the group consisting of hexamethylene diisocyanate, trimethyl hexamethylene diisocyanate, isophorone diisocyanate, tetramethyl xylene diisocyanate, and and 4,4-methylene bis(cyclohexylisocyanate).

17. A polymer chemical which is made by reacting:
a) a monomer unit containing a moiety selected from the group consisting of an alkyl group, an aryl group or an alkyl aryl group;
b) poly(ethylene) glycol; and
c) one or more of the following diols: poly(tetrahydrofuranol), poly(caprolactone), poly(carbonate), ethylene glycol, propylene glycol, and 1,2-dodecanediol.

18. The polymer according to claim 17, wherein the polymer contains at least two linking units.

19. The polymer according to claim 18, wherein said linking units comprise one or more of the following: a urethane linking unit, an ester linking unit; an amide linking unit; and an urea linking unit.

20. The polymer according to claim 18, wherein the linking units comprise urethane links obtained from compounds selected from the group consisting of hexamethylene diisocyanate, trimethyl hexamethylene diisocyanate, isophorone diisocyanate, tetramethyl xylene diisocyanate, and 4,4-methylene bis(cyclohexylisocyanate).
